(19) United States
(12) Patent Application Publication
(10) Pub. No.: US 2025/0011955 A1
(43) Pub. Date: Jan. 9, 2025

(54) ELECTROLZYER STACKS, ELECTROLYSIS SYSTEMS, AND METHODS FOR OPERATING ELECTROLYSIS SYSTEMS INCLUDING ACTIVE COMPRESSION

(71) Applicant: GM GLOBAL TECHNOLOGY OPERATIONS LLC, Detroit, MI (US)

(72) Inventor: Yeh-Hung Lai, Oakland, MI (US)

(73) Assignee: GM GLOBAL TECHNOLOGY OPERATIONS LLC, Detroit, MI (US)

(21) Appl. No.: 18/347,003

(22) Filed: Jul. 5, 2023

(51) Int. Cl. C25B 15/04; C25B 1/04; C25B 9/77; C25B 15/023; C25B 15/08

(52) U.S. Cl. CPC C25B 15/04; C25B 1/04; C25B 9/77; C25B 15/023; C25B 15/087

(57) ABSTRACT

An electrolyzer stack, an electrolysis system, and a method for operating an electrolysis system are provided. In one example, the electrolyzer stack includes a cell block that includes a plurality of cells configured to receive and convert water to form a hydrogen product stream. The electrolyzer stack includes a force applicator, when pressurized, configured to apply a force to the cell block to counter dimensional changes (e.g., expansion or contraction) to the electrolyzer stack. The force applied by the force applicator is based on the pressure of the hydrogen product stream.

### INTRODUCTION

The present disclosure relates generally to electrolyzers, and more particularly, relates to electrolyzer stacks including a cell block and a force applicator for applying a force to the cell block, electrolysis systems including such electrolyzer stacks, and methods for operating such electrolysis systems.

An electrolyzer is an electrochemical device that converts water into hydrogen and oxygen using the process of electrolysis. Electrolyzers are commonly used to produce hydrogen. Hydrogen is used in many industrial applications, such as, for example ammonia production. Electrolyzers may be used for localized hydrogen production, for example as fuel for vehicles equipped with hydrogen fuel cells. Electrolyzers may also be used to store energy from dynamic electrical sources, such as wind turbines and solar cells.

### SUMMARY

An electrolyzer stack for an electrolysis system is provided. An electrolyzer stack includes a cell block, a force applicator, a pressure transducer, and pressure source. The cell block includes a plurality of cells configured to receive and convert water to form a hydrogen product stream. The force applicator is configured to apply force to the electrolyzer cell block when pressurized. The pressure transducer is configured to monitor pressure of the hydrogen product stream. The pressure source is configured to pressurize the force applicator in response to the pressure of the hydrogen product stream.

In some embodiments, the pressure source includes a reservoir for containing a fluid, and wherein the pressure source is configured to fluidly communicate the fluid to the force applicator to pressurize the force applicator.

In some embodiments, the fluid is chosen from water, nitrogen, or hydraulic fluid.

In some embodiments, the force applicator is chosen from a force applicator, a bladder, a piston, or a telescoping hydraulically actuating device.

In some embodiments, the electrolyzer stack further includes a compression plate disposed between the force applicator and the cell block, wherein the force applicator when pressurized applies the force to the compression plate that transfers to the cell block.

In some embodiments, the electrolyzer stack further includes a first end plate disposed adjacent to the force applicator opposite compression plate.

In some embodiments, the electrolyzer stack further includes a second end plate disposed adjacent to the cell block on a side opposite the compression plate, wherein the first and second end plates are linked together to constrain expansion of the electrolyzer stack including constraining expansion of the force applicator in a direction away from the cell block.

In some embodiments, the electrolyzer stack further includes a tension rod that extends between and at least partially links the first and second end plates together.

In some embodiments, the electrolyzer stack further includes a spring that is coupled to and cooperates with the tension rod to link the first and second end plates together.

In some embodiments, the plurality of cells correspondingly includes a plurality of seals that are disposed between the compression plate and the second end plate and that overlie each other to define a perimeter that is disposed about an active zone of the cell block.

In some embodiments, the force applicator overlies at least a portion of the active zone of the cell block.

In some embodiments, the force applicator has an outer-most periphery that is substantially superposed with the perimeter defined by the plurality of seals.

In some embodiments, the force applicator has an outer-most periphery that overlies the active zone inboard of the perimeter defined by the plurality of seals.

In some embodiments, the electrolyzer stack further includes a pair of terminal plates including a first terminal plate disposed between the cell block and the compression plate and a second terminal plate that is disposed between the cell block and the second end plate, wherein the force applicator overlies the first terminal plate.

In some embodiments, the pair of terminal plates is configured to communicate electricity to the cell block to drive electrolysis of water to form the hydrogen product stream.

According to an alternative embodiment, an electrolysis system includes a water source, a power source, and an electrolyzer stack. The electrolyzer stack includes a cell block. The cell block includes a plurality of cells in fluid communication with the water source to receive water and in communication with the power source to electrolyze water to form a hydrogen product stream. The electrolyzer stack further includes a force applicator configured to apply a force to the cell block when pressurized. The electrolyzer stack further includes a pressure transducer configured to monitor pressure of the hydrogen product stream. The electrolyzer stack further includes a pressure source in fluid communication with the force applicator and a pressure controller in communication with the pressure transducer and is configured to direct the pressure source to pressurize the force applicator in response to the pressure of the hydrogen product stream.

In some embodiments, the electrolysis system further includes power electronics in communication with the electrolyzer stack and is configured to control operation of the cell block to produce the hydrogen product stream, and wherein the pressure controller forms part of the power electronics or is independent of the power electronics.

In some embodiments, the electrolysis system further includes a recycle stream that is in fluid communication with the electrolyzer stack and the water source to recycle a remaining portion of water from the electrolyzer stack to the water source.

In some embodiments, the electrolysis system is operably disposed in a vehicle.

According to an alternative embodiment, a method for operating an electrolysis system is provided. The method includes introducing water to an electrolyzer stack that includes a cell block. The method further includes electrolyzing water in the cell block to form a hydrogen product stream. The method further includes monitoring pressure of the hydrogen product stream via a pressure transducer. The method further includes directing a pressure source via a pressure controller to pressurize a force applicator that thereby applies a force to the cell block in response to the pressure of the hydrogen product stream.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic view of an electrolysis system, according to one or more embodiments of the disclosure.

FIG. 2 is a schematic top view of a portion of an electrolysis system including an electrolyzer stack, according to one or more embodiments of the disclosure.

FIG. 3 is a cross-sectional view of the electrolyzer stack depicted in FIG. 2 along line 3-3.

FIG. 4 is a flowchart of a method for operating an electrolysis system, according to one or more embodiments of the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about.”

Electrolyzers are categorized into three main types: alkaline electrolyzers, solid oxide electrolyzers, and proton exchange membrane (PEM) electrolyzers. Alkaline electrolyzers use an alkaline solution as an electrolyte, such as potassium hydroxide (KOH) or sodium hydroxide (NaOH). Solid oxide uses a solid ceramic material as an electrolyte, which conducts oxygen ions at high temperatures (typically around 800° C. to 1000° C.). In one example, PEM electrolyzers include a cell block formed of a plurality of stacked cells (e.g., in series) in which each cell includes various components including various membrane electrode assembly (MEA) components. The MEA components include a solid polymer membrane (i.e., proton exchange membrane or PEM) that is disposed between an anode and a cathode. The MEA components that make up the cathode include a catalyst layer disposed adjacent to a gas diffusion layer (GDL). Likewise, the MEA components that make up the anode include a catalyst layer disposed adjacent to a porous transport layer (PTL). The PEM selectively allows positively charged hydrogen ions to pass through the membrane between the anode and the cathode as part of the electrolysis process to convert water into hydrogen and oxygen.

PEM electrolyzers may be designed to apply a force (e.g., a compressive force) to the cell block during operation to counter increase pressure(s) that is produced from converting liquid water to hydrogen gas to operate more efficiently. The force helps prevent hydrogen leakage and reduces contact resistance along the cell block by countering dimensional changes (e.g., expansion or contraction) of the PEM electrolyzer's stack length (e.g., stack height). The change in the PEM electrolyzer's stack length may be caused, for example, by swelling, thermal expansion, and/or creep of the various components, such as, for example, the seal gasket(s) that seals the cells of the cell block, and/or one or more of the various MEA components within the cell block. Some of the current designs are ineffective due to swelling, thermal expansion, creep, and/or high pressures.

In high pressure electrolyzers, for example where up to 30 bars (3 MPa) or more of hydrogen pressure may be produced, issues or concerns of hydrogen leakage and/or reduction in electrolysis effectiveness may be further increased. In such electrolyzers, the increased pressures also increase the hardware used to apply a force to counter dimensional changes of the electrolyzer's stack length. The additional hardware increases an electrolyzer's stack volume, weight, and design complexity.

Accordingly, it is desirable to provide electrolyzer stacks that address one or more of the foregoing issues, electrolysis systems including such electrolyzer stacks, and methods for operating such electrolysis systems. Furthermore, other desirable features and characteristics of the various embodiments described herein will become apparent from the subsequent detailed description and the appended claims, taken in conjunction with the accompanying drawings and this background.

The present disclosure relates generally to electrolyzers, and more particularly, relates to electrolyzer stacks including a cell block and a force applicator for applying a force to the cell block, electrolysis systems including such electrolyzer stacks, and methods for operating such electrolysis systems.

In one or more embodiments of the disclosure, the electrolyzer stack includes a cell block that includes a plurality of cells configured to receive and convert water to form a hydrogen product stream. A force applicator is configured to apply a force to the cell block (i.e., electrolyzer cell block) when pressurized by a pressure source. The pressure source is configured to pressurize the force applicator in response to the pressure of the hydrogen product stream. A pressure transducer (e.g., a sensor, sensor arrangement, or other device for sensing pressure) is configured to monitor the pressure of the hydrogen product stream. A pressure control may be used to communicate with the pressure transducer and the pressure source.

In one or more embodiments of the disclosure, the electrolyzer stack is part of an electrolysis system. The electrolysis system further includes a water source and a power source that are configured to communicate with the electrolyzer stack. During operation of the electrolysis system, liquid water is fluidly communicated from the water source to the electrolyzer stack and electricity is communicated from the power source to the electrolyzer stack. The electrolyzer stack converts the liquid water feedstock using electricity to produce the hydrogen product stream via electrolysis. The pressure transducer monitors the pressure of the hydrogen product stream and communicates with a pressure controller. The pressure controller communicates and directs a pressure source to pressurize the force applicator in response to the pressure of the hydrogen product stream. The force applicator applies a force to the cell block when pressurized by the pressure source.

In an exemplary embodiment, advantageously hydrogen leakage is reduced, minimized, or prevented, and the electrolysis effectiveness is improved in the cell block as a result of the higher force(s) being applied by the force applicator to counter any dimensional changes to the cell block and/or electrolyzer stack.

In another exemplary embodiment, if creep (e.g., compression set, etc.) has occurred in one or more of the cell block components, the effect of creep is reduced, minimized, or eliminated because the force applicator applies a force to the cell block compensating for the effect of creep. Since the force applicator pressure may simultaneously compensate the effect of dimensional change of the cell block components and counter the internal hydrogen pressure of the electrolyzer stack, the length of electrolyzer stack will adjust accordingly to ensure tight contact between the adjacent the cell block components.

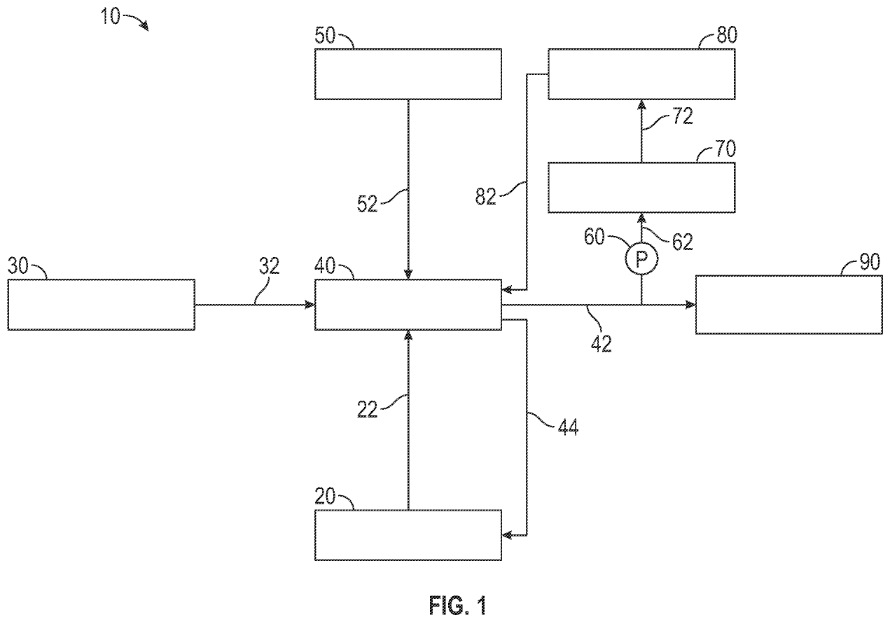

FIG. 1 is a schematic view of an electrolysis system 10, according to one or more embodiments of the disclosure. As illustrated, the electrolysis system 10 includes a water source 20 that is in fluid communication with an electrolyzer stack 40 via line 22 to provide a water feedstock to the electrolyzer stack 40. Any unused, remaining and/or by-product water is returned from the electrolyzer stack 40 to the water source 20 via a recycle stream line 44. Additionally, a power source 30 and power electronics 50 are in communication with the electrolyzer stack 40 via lines 32 and 52, respectively.

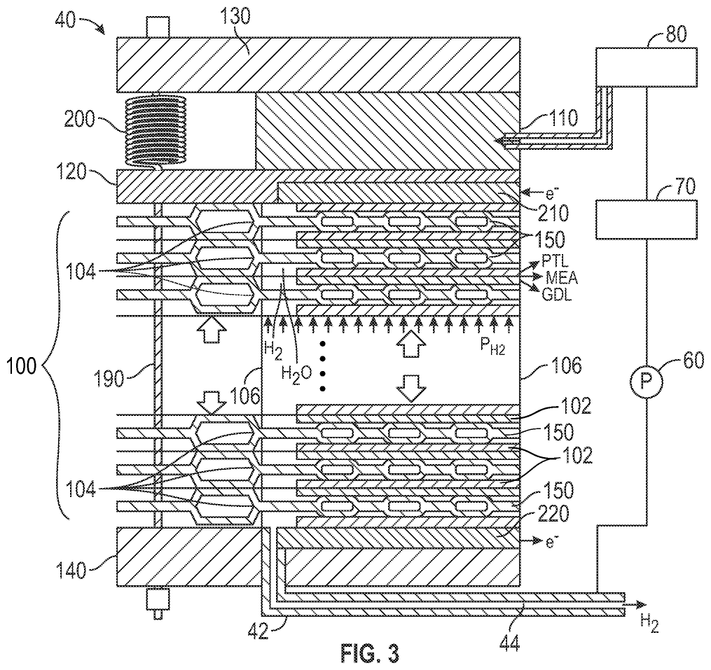

Additionally, a pressure controller 70 is in communication with a pressure transducer 60 and a pressure source 80. The pressure transducer 60 (e.g., a sensor, sensor arrangement, or other device for sensing pressure) is configured to monitor the pressure of a hydrogen product stream 44 (shown in FIG. 3) advancing through a hydrogen product line 42.

The pressure controller 70 is configured to direct the pressure source 80 to pressurize a force applicator 110 (shown in FIG. 3 and discussed below) of the electrolyzer stack 40 in response to the pressure of the hydrogen product stream 44. The pressure source 80 is in fluid communication with the electrolyzer stack 40 via line 82 and is configured to pressurize a force applicator 110 of the electrolyzer stack 40. The force applicator 110 is configured to apply a force when pressurized to counter dimensional changes of the length (i.e., height) of the electrolyzer stack 40. The pressure controller 70 may form part of the power electronics 50 or may be independent of the power electronics 50.

The pressure controller 70 may be embodied as one or multiple digital computers or data processing devices, each having one or more microprocessors or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, power electronics/transformers, and/or signal conditioning and buffering electronics. The individual control routines/systems resident in the pressure controller 70 or readily accessible thereby may be stored in ROM or other suitable tangible memory location and/or memory device, and automatically executed by associated hardware components of the pressure controller 70 to provide the respective control functionality.

In one or more embodiments of the disclosure, a hydrogen storage device 90 is in fluid communication with the electrolyzer stack 40 via the hydrogen product line 42 to receive hydrogen product that is produced during electrolysis in the electrolyzer stack 40, as will be discussed in further detail below.

As illustrated, the electrolyzer stack 40 receives electricity (i.e., an electrical current) from the power source 30 via line 32 and water from the water source 20 via line 22. The electrolyzer stack 40 convert water from the water source 20 into hydrogen and oxygen via electrolysis using electricity supplied by the power source 30. Hydrogen gas is output from the electrolyzer stack 40 as a hydrogen product stream 44 (shown FIG. 3) and is advanced to the hydrogen storage device 90 via line 42.

During operation of the electrolysis system 10, the power source 30 supplies direct current to the electrolyzer stack 40. Examples of power sources include, but are not limited to, batteries, solar cells, DC generators, wind turbines, hydropower plants, and/or the like.

The power electronics 50 are in communication with the electrolyzer stack 40 and are configured to control the operation of the electrolyzer stack 40. For example, the power electronics 50 may control the amount of voltage and current supplied to the electrolyzer stack 40 from the power source 30.

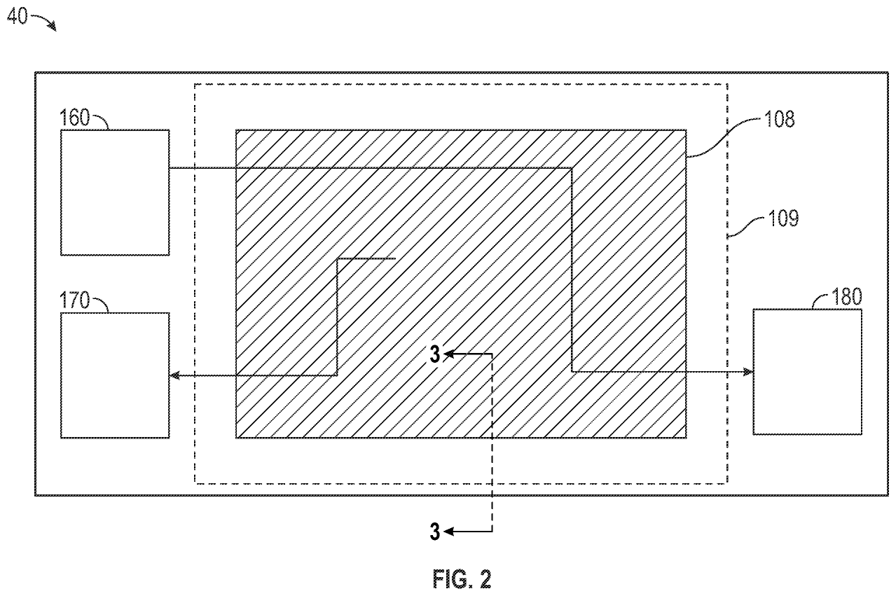

FIG. 2 is a schematic top view of a portion of an electrolysis system 10 including the electrolyzer stack 40, according to one or more embodiments of the disclosure. FIG. 3 is a cross-sectional view of the electrolyzer stack 40 depicted in FIG. 2 along line 3-3. Referring to FIGS. 1-3, in one or more embodiments of the disclosure, the electrolyzer stack 40 includes a cell block 100 and a force applicator 110. The cell block 100 includes a plurality of cells 102 (e.g., electrolyzer cells) configured to receive and convert water to form a hydrogen product stream 44. The force applicator 110 is configured to apply a force indirectly or directly to the cell block 100 based on the pressure of the hydrogen product stream 44 to counter dimensional changes to the length (i.e., height) of the cell block 100.

The plurality of cells 102 includes a plurality of seals 104 and a plurality of separator plates 150. The cells in the plurality of cells 102 are stacked in the cell block 100 and are electrically connected in series. Each cell in the plurality of cells 102 includes various components, including membrane electrode assembly (MEA), a pair of separator plates, and a pair of seals.

The pair of separator plates (from the plurality of separator plates 150) contains flow channels that interface with the MEA and that allow the flow of fluids (e.g., water, hydrogen gas, and oxygen gas) to or from the MEA. Each separator plate is electrically conductive and facilitates the transport of electrons to assist in establishing electrical circuit of the electrolysis process.

The MEA includes a solid polymer membrane (i.e., proton exchange member or PEM), an anode (i.e., anode-catalyst layer), and a cathode (i.e., cathode-catalyst layer). The PEM is disposed between the anode-catalyst layer and the cathode-catalyst layer. The cathode-catalyst layer is disposed adjacent to a gas diffusion layer (GDL). Likewise, the anode-catalyst layer is disposed adjacent to a porous transport layer (PTL). The PEM contains an active zone where the electrochemical reaction for the conversion of water to hydrogen via electrolysis occurs. The PEM selectively allows positively charged hydrogen ions to pass through the membrane between the anode and the cathode as part of the electrolysis process to convert water into hydrogen and oxygen.

Each cell is structured such that the MEA is disposed between the pair of separator plates. The pair of seals (from the plurality of seals 104) prevent leakage of fluids (e.g., water, hydrogen gas, and oxygen gas) from the interface between the MEA and the pair of separator plates. The pair of seals defines an MEA perimeter 109 (shown in FIG. 2). The MEA perimeter 109 is an area where the fluids are confined prior to exiting the MEA via the pair of separator plates.

The MEA perimeter 109 is related to a perimeter region 106. The perimeter region 106 is a region defined by the plurality of seals 104 and the MEA perimeter 109 of each seal in the plurality of seals 104. In other words, the MEA perimeter 109 is related to a cell and the perimeter region 106 is related to the plurality of cells 102.

As illustrated, the electrolyzer stack 40 receives water from the water source 20 via line 22 line and an electrical current from the power source 30 via line 32. The electrolyzer stack 40 may receive the electrical current through a wiring, a bus, and/or an electrical connector (not shown), where for example, the electrical connector is electrically coupled to a terminal plate 210 (e.g., first terminal plate).

Water is advanced into and through the cell block 100 via a water inlet 160 that feeds the plurality of cells 102 via the plurality of separator plates 150. The terminal plates 210 and 220, the plurality of separator plates 150, each MEA in the plurality of cells 102 create an electrical circuit that drives the electrolysis process when electrical current is applied to the cell block 100. When electrical current is passed through the plurality of cells 102 between the terminal plates 210 and 220, water advancing in the plurality of cells 102 is converted into hydrogen and oxygen via an electrolysis process.

As illustrated, oxygen gas and any unused, remaining and/or by-product water is removed from the plurality of cells 102 via a water-and-oxygen outlet 180. The water-and-oxygen outlet 180 advances the removed water to the recycle stream line 44, which passes the water back to the water source 20.

The hydrogen gas produced in the plurality of cells 102 is advanced to the hydrogen header 170. From the hydrogen header 170, the hydrogen gas exits the electrolyzer stack 40 to form the hydrogen product stream 44. The hydrogen product stream 44 advances through the hydrogen product line 42.

The pressure transducer 60 measures the pressure of the hydrogen product stream 44 advancing through the hydrogen product line 42. The pressure transducer 60 transmits pressure data associated with the hydrogen product stream 44 to the pressure controller 70. Since the hydrogen product stream 44 is formed from the hydrogen produced during the electrolysis process, the pressure of the hydrogen product stream 44 is equivalent or substantively equivalent to the internal pressure of the electrolyzer stack 40.

The pressure controller 70 receives the pressure data and calculates the total force (i.e., the force applied to the internal structure of the electrolyzer stack 40 caused by hydrogen pressure) using the following equation:

$${F}_{H 2} = {P}_{H 2} \times {A}_{H 2} , \qquad ( 1 )$$

where F_{H2} represents the total force from the hydrogen pressure located within the electrolyzer stack 40, P_{H2} represents the hydrogen pressure associated with the pressure data, and A_{H2} is an area defined by the perimeter region 106. A_{H2} is the same since all electrolyzer cells in the plurality of electrolyzer cells are equivalent and stacked in an aligned configuration as shown in FIG. 3.

The pressure controller 70 then calculates the required pressure to pressurize the force applicator 110 to counter dimensional changes to the electrolyzer's stack length using the following equation:

$${P}_{A} = ( {F}_{H 2} + {F}_{baseline} ) / {A}_{A} , \qquad ( 2 )$$

where P_{A} represents the required pressure to pressurize the force applicator 110, total force F_{H2} represents the total force from the hydrogen pressure located within the electrolyzer stack 40, F_{baseline} represents the stack compression force (i.e., stack force) required for sealing pressure (i.e., pressure required to maintain the seal of seal gaskets (and/or the like) to prevent leakage of a fluid) and low electrical contact resistance when hydrogen pressure is zero, and A_{A} represents the area of the force applicator 110 that is in physical contact with the compression plate 120. F_{baseline} is typically the stack force applied when the electrolyzer stack 40 is assembled before the start of hydrogen production. The assembly may include (as discussed below in greater detail), a tension rod 190, and optionally a spring 200 (i.e., stack spring(s)), extending between and at least partially linking the end plates 130 and 140 of the electrolyzer stack 40 to constrain or compression the components of the electrolyzer stack 40. In the case when stack springs are used to maintain the stack force from the component dimensional changes by swelling, thermal expansion, and/or creep, the F_{baseline} does not need to be considered in controlling the force applicator 110 and thus, F_{baseline} can be considered zero in Equation 2.

The total force (i.e., F_{H2} plus F_{baseline}) is applied to the compression plate of the cell block 100 to maintain the seals 104 to prevent water and product gas leakage while countering increase pressure(s) that is produced from converting liquid water to hydrogen gas. The total force also enhances the electrically conductive of the cell block 100 by reducing the electrical contact resistance. The electrical contact resistance is the electrical connection point (i.e., the interface among the plurality of cells 102 and the components of a cell) that opposes the flow of electric current.

Next, the pressure controller 70 directs the pressure source 80 to pressurize, or to adjust the internal pressure of, the force applicator 110. The pressure source 80 includes a reservoir for containing a fluid. The fluid may be water, nitrogen, a hydraulic fluid, and/or the like.

While the force applicator 110 is pressurized, the force applicator 110 applies a force (e.g., a compressive force or a force in the direction of the cell block 100) directly or indirectly to a compression plate 120 (e.g., moveable compression plate) that facilitates evenly distributing and transferring the force to the cell block 100. As illustrated, the compression plate 120 is disposed adjacent to and between the force applicator 110 and the cell block 100.

The amount of force applied by the force applicator 110 depends on the total force F_{H2} and F_{baseline}. The force applied by the force applicator 110 is an opposing force to the total force from the hydrogen pressure located within the electrolyzer stack 40. Because the portion of the force of the force applicator 110 to counter the force from the hydrogen pressure are equivalent, or substantially equivalent, in magnitude, the compression plate 120 remains stationary when hydrogen pressure changes during the hydrogen production. Thus, the length of electrolyzer stack 40 does not change with varying hydrogen pressure, thereby remaining substantially dimensionally stable. Further, if any creep (e.g., compression set, etc.) has occurred in one or more of the cell block 100 components (e.g., seals 104, etc.), because the force applicator pressure equals the internal pressure of the electrolyzer stack 40, the length of electrolyzer stack 40 will adjust accordingly to ensure tight contact between the cell block 100 components.

In some embodiments, the electrolyzer stack 40 includes the cell block 100, a compression plate 120, the force applicator 110, an end plate 130 (e.g., first end plate), an end plate 140 (e.g., second end plate), the hydrogen product line 42, the pressure transducer 60, the pressure controller 70, the pressure source 80, a tension rod 190, a spring 200, the terminal plate 210, the terminal plate 220, the plurality of cells 102, and a plurality of seals 104.

As briefly discussed above, the plurality of cells 102 corresponding includes the plurality of seals 104 that overlie each other to define the perimeter region 106 that is disposed about an active zone 108 of the cell block 100. As used herein, the phase “active zone” is understood to mean the zone or region where the electrochemical reaction for the conversion of water to hydrogen via electrolysis occurs. As illustrated, the force applicator 110 overlies the active zone 108 of the cell block 100. As used herein, the term “overlies” is understood to mean that in one or more orientations of the cell block 100, the force applicator 110 is over the cell block 100, while in other orientations, although the force applicator 110 may not be over the cell block 100, the force applicator 110 is either directly or indirectly adjacent to the cell block 100.

As illustrated, the cell block 100 is disposed adjacent to and between the terminal plates 210 and 220. On the side opposite the cell block 100 of the terminal plate 210, the compression plate 120 is disposed adjacent to and between the terminal plate 210 and the force applicator 110. Further and as illustrated, the force applicator 110 is disposed adjacent to and between the compression plate 120 and the end plate 130. The end plate 130 is disposed adjacent to the force applicator 110 opposite the compression plate 120.

As discussed above, the force applicator 110, when pressurized, applies the force to the compression plate 120 that transfers to the cell block 100. In one or more embodiments of the disclosure, the force applicator 110 applies the force over the area of the force applicator 110 that is in physical contact with the compression plate 120. This area (i.e., force applicator area) is the portion of the force applicator 110 that is in physical contact with the compression plate 120.

The force applicator 110 may be a force applicator, a bladder, a piston, a telescoping hydraulically actuating device, and/or the like. In an exemplary embodiment, the bladder is formed of or otherwise includes an elastic material that can be expanded and contracted without significant plastic deformation. Further, in an exemplary embodiment, the bladder may contain accordion-fold (e.g., pleated or foldable wall sections) walls that overlay each other forming one or more “V” or folded shapes when the bladder is unpressurized or in a collapsed position. When the bladder 80 is pressurized, the accordion-fold walls expand, for example, the foldable wall sections (e.g., the “V’ folded shape(s)) unfold to increase the length of the wall. Non-limiting examples of the elastic material suitable for forming the force applicator 110 include polymer material such as rubbers and fiber reinforced thermoplastic polymers or metals such as stainless steel and aluminum.

On a side of the cell block 100 opposite the force applicator 110, the terminal plate 220 is disposed adjacent to and between the cell block 100 and the end plate 140. The terminal plates 210 and 220 (i.e., pair of terminal plates) are electrically conductive to allow electricity to be passed through to the cell block 100 to drive the electrolysis of water to form the hydrogen product stream 44.

As illustrated, the hydrogen product stream 44 is passed through an opening or conduit in the end plate 140. The hydrogen product stream 44 is formed of the hydrogen produced by the electrolysis of water.

In some embodiments, the electrolyzer stack 40 does not include the spring 200. Instead, the electrolyzer stack 40 includes the cell block 100, the compression plate 120, the force applicator 110, the end plate 130 (e.g., first end plate), the end plate 140 (e.g., second end plate), the hydrogen product line 42, the pressure transducer 60, the pressure controller 70, the pressure source 80, a tension rod 190, the terminal plate 210, the terminal plate 220, the plurality of cells 102, and the plurality of seals 104.

In such embodiment, the force applicator 110 is required to account for the F_{baseline}, as discussed above in Equation (2), since the spring 200 is not included in the electrolyzer stack 40. F_{baseline} may be predetermined based on the characteristic of the electrolyzer stack 40, for example the active zone (or active area) of the electrolyzer stack 40 and the pressure associated with the active zone (or active area). This pressure may range from about 0.2 megapascals to about 3 megapascals but is typically within the range of about 1 megapascals to about 2 megapascals. In some embodiments, the pressure may exceed about 3 megapascals.

Alternatively, the F_{baseline} may be determined based on the pressure values of the initial operation state of the electrolyzer stack 40. For example, the force applicator 100 applies a force (e.g., an initial or nominal force) to the compression plate 120 prior to production of hydrogen by the electrolyzer stack 40. Then, the electrolyzer stack 40 receives electricity and starts producing hydrogen gas, where the pressure of the hydrogen gas is measured by the pressure transducer 60. The initial pressure measurements of hydrogen gas are used to calculate an initial force. The initial force is combined with the force from the force applicator 100 to determine the F_{baseline}. The initial pressure measurements of hydrogen gas may occur over a short time duration, for example, about 30 seconds.

In an exemplary embodiment, the force applicator 110 has an outer-most periphery that is substantially superposed with the perimeter defined by the plurality of seals 104. In an exemplary embodiment, the force applicator 110 has an outer-most periphery that overlies the active zone inboard of the perimeter defined by the plurality of seals 104.

In an exemplary embodiment, the tension rod 190 and spring 200 (i.e., stack spring) are coupled and cooperate to compress the cell block 100 by linking together the end plates 130 and 140. The end plates 130 and 140 are linked together to constrain expansion of the electrolyzer stack 40 including constraining expansion of the force applicator 110 in a direction away from the cell block 100. In an exemplary embodiment, this helps ensure that the force applicator 110, when pressurized, directs the force towards the cell block 100.

In an exemplary embodiment, the tension rod 190 and spring 200 further help provide an additional force to the cell stack 40 to ensure that some level of force is always being applied to the plurality of seals 104 and the active zone 108 despite any fluctuations in pressure and/or dimensional changes to the cell block 100 that could occur during operation and/or start-up of the electrolysis system 10.

In an exemplary embodiment, the tension rod 190 (excluding the spring 200) extends between and at least partially links the end plates 130 and 140. The end plates 130 and 140 are linked together to constrain expansion of the electrolyzer stack 40 including constraining expansion of the force applicator 110 in a direction away from the cell block 100. In an exemplary embodiment, this helps ensure that the force applicator 110, when pressurized, directs the force towards the cell block 100.

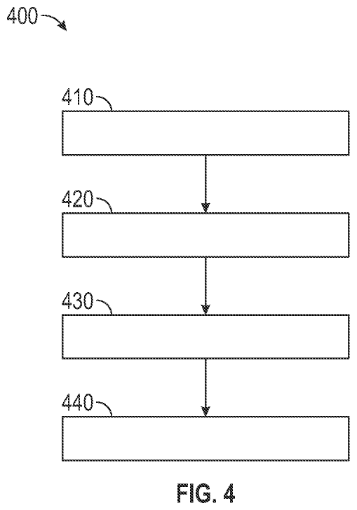

FIG. 4 is a flowchart of a method 400 for operating an electrolysis system 10, according to one or more embodiments of the disclosure. The method 400 includes introducing (STEP 410) water to an electrolyzer stack 40 that includes a cell block 100.

The method 400 continues by electrolyzing (STEP 420) water in the cell block to form a hydrogen product stream. The method 400 continues by monitoring (STEP 430) the pressure of the hydrogen product stream via a pressure transducer.

The method 400 continues by directing (STEP 440) a pressure source via a pressure controller to pressurize a force applicator in response to the pressure of the hydrogen product stream. When pressurized, the force applicator applies a force to the cell block to counter dimensional changes of the length (i.e., height) of the electrolyzer stack. While the best modes for carrying out the disclosure have been described in detail, those familiar with the art to which this disclosure relates will recognize various alternative designs and embodiments for practicing the disclosure within the scope of the appended claims.

In an exemplary embodiment, the electrolysis system 10 is incorporated or otherwise used in a vehicle, for example, a motor vehicle. As used herein a “vehicle” is understood to mean a device configured for transporting people, things, objects, or the like. Non-limiting examples of motor vehicles (e.g., internal combustion engine (ICE) vehicles, electric motor vehicles including electric battery and fuel cell vehicle or the like) include land vehicles (e.g., cars, trucks, motorcycles, electric bike, buses, trains or the like), aerial vehicles (e.g., airplanes, helicopters, unmanned aerial vehicles or the like), water vehicles (e.g., boats, watercrafts, or the like) and amphibious vehicles (e.g., hovercrafts or the like).

Any of the dimensions, configurations, etc. discussed herein may be varied as needed or desired to be different than any value or characteristic specifically mentioned herein or shown in the drawings for any of the embodiments.

It will be apparent to those skilled in the art that various modifications and variations can be made to the embodiments of the apparatus and methods of assembly as discussed herein without departing from the scope or spirit of the disclosure(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments to provide still further embodiments.

What is claimed is:

1. An electrolyzer stack comprising:
a cell block comprising a plurality of cells configured to receive and convert water to form a hydrogen product stream;
a force applicator configured to apply force to the electrolyzer cell block when pressurized;
a pressure transducer configured to monitor pressure of the hydrogen product stream; and
a pressure source configured to pressurize the force applicator in response to the pressure of the hydrogen product stream.

2. The electrolyzer stack of claim 1, wherein the pressure source comprises a reservoir for containing a fluid, and wherein the pressure source is configured to fluidly communicate the fluid to the force applicator to pressurize the force applicator.

3. The electrolyzer stack of claim 2, wherein the fluid is chosen from water, nitrogen, or hydraulic fluid.

4. The electrolyzer stack of claim 1, wherein the force applicator is chosen from a force applicator, a bladder, a piston, or a telescoping hydraulically actuating device.

5. The electrolyzer stack of claim 1, further comprising a compression plate disposed between the force applicator and the cell block, wherein the force applicator when pressurized applies the force to the compression plate that transfers to the cell block.

6. The electrolyzer stack of claim 5, further comprising a first end plate disposed adjacent to the force applicator opposite compression plate.

7. The electrolyzer stack of claim 6, further comprising a second end plate disposed adjacent to the cell block on a side opposite the compression plate, wherein the first and second end plates are linked together to constrain expansion of the electrolyzer stack including constraining expansion of the force applicator in a direction away from the cell block.

8. The electrolyzer stack of claim 7, further comprising a tension rod that extends between and at least partially links the first and second end plates together.

9. The electrolyzer stack of claim 8, further comprising a spring that is coupled to and cooperates with the tension rod to link the first and second end plates together.

10. The electrolyzer stack of claim 7, wherein the plurality of cells correspondingly comprises a plurality of seals that are disposed between the compression plate and the second end plate and that overlie each other to define a perimeter that is disposed about an active zone of the cell block.

11. The electrolyzer stack of claim 10, wherein the force applicator overlies at least a portion of the active zone of the cell block.

12. The electrolyzer stack of claim 11, wherein the force applicator has an outer-most periphery that is substantially superposed with the perimeter defined by the plurality of seals.

13. The electrolyzer stack of claim 11, wherein the force applicator has an outer-most periphery that overlies the active zone inboard of the perimeter defined by the plurality of seals.

14. The electrolyzer stack of claim 7, further comprising a pair of terminal plates including a first terminal plate disposed between the cell block and the compression plate and a second terminal plate that is disposed between the cell block and the second end plate, wherein the force applicator overlies the first terminal plate.

15. The electrolyzer stack of claim 14, wherein the pair of terminal plates are configured to communicate electricity to the cell block to drive electrolysis of water to form the hydrogen product stream.

16. An electrolysis system comprising:
a water source;
a power source;
an electrolyzer stack comprising:
a cell block comprising a plurality of cells in fluid communication with the water source to receive water and in communication with the power source to electrolyze water to form a hydrogen product stream;
a force applicator configured to apply a force to the cell block when pressurized;
a pressure transducer configured to monitor pressure of the hydrogen product stream; and
a pressure source in fluid communication with the force applicator; and
a pressure controller in communication with the pressure transducer and configured to direct the pressure source to pressurize the force applicator in response to the pressure of the hydrogen product stream.

17. The electrolysis system of claim 16, further comprising power electronics in communication with the electrolyzer stack and configured to control operation of the cell block to produce the hydrogen product stream, and wherein the pressure controller forms part of the power electronics or is independent of the power electronics.

18. The electrolysis system of claim 16, further comprising a recycle stream that is in fluid communication with the electrolyzer stack and the water source to recycle a remaining portion of water from the electrolyzer stack to the water source.

19. The electrolysis system of claim 16, wherein the electrolysis system is operably disposed in a vehicle.

20. A method for operating an electrolysis system, the method comprising:
introducing water to an electrolyzer stack comprising a cell block;
electrolyzing water in the cell block to form a hydrogen product stream;
monitoring pressure of the hydrogen product stream via a pressure transducer;
directing a pressure source via a pressure controller to pressurize a force applicator that thereby applies a force to the cell block in response to the pressure of the hydrogen product stream.
